(19) United States
(12) Patent Application Publication
(10) Pub. No.: US 2014/0090538 A1
(43) Pub. Date: Apr. 3, 2014

(54) METHOD FOR STRIPPING LONG SEGMENTS OF BUFFERED OPTICAL FIBER AND A TOOL FOR PERFORMING THE SAME

(71) Applicant: Corning Cable Systems LLC, Hickory, NC (US)

(72) Inventor: Elli Makrides-Saravanos, Highland Village, TX (US)

(73) Assignee: Corning Cable Systems LLC, Hickory, NC (US)

(21) Appl. No.: 14/099,915

(22) Filed: Dec. 7, 2013

Related U.S. Application Data
(63) Continuation of application No. PCT/US13/25045, filed on Feb. 7, 2013.
(60) Provisional application No. 61/597,398, filed on Feb. 10, 2012.

(51) Int. Cl. G02B 6/245; B26D 1/09

(52) U.S. Cl. CPC G02B 6/245; B26D 1/09
USPC 83/861; 30/90.1

(57) ABSTRACT

A method and optical fiber stripper for removing one or more coatings from an optical fiber is disclosed. The method includes inserting an optical fiber into an optical fiber stripper comprising a pair of fiber stress distributing elements, wherein a normal stress is applied to the fiber by the fiber stress distributing elements along the length of fiber intended to be stripped. The optical fiber stripper includes a pair of grip members, a cutting mechanism, and a pair of fiber stress distributing elements.

### RELATED APPLICATIONS

This application is a continuation of International Application No. PCT/US13/25045, filed Feb. 7, 2013, which claims the benefit of priority to U.S. Application No. 61/597,398, filed Feb. 10, 2012, both applications being incorporated herein by reference in their entirety.

### BACKGROUND

The disclosure is directed to an optical fiber stripper for removing one or more coatings from an optical fiber.

Optical fiber is increasingly being used for a variety of applications in both public and private networks for broadband voice, video, data transmission, and the like. Benefits of optical fiber use include extremely wide bandwidth and low noise operation. With the increasing and varied use of optical fibers, it is important to provide efficient methods of interconnecting and reconfiguring optical fiber pathways. Fiber optic cable is comprised of an outer jacket which contains at least one optical fiber within. The optical fiber is protected within the cable by its own coatings and/or buffering materials to protect each individual optical fiber. These coatings and buffering materials must be removed by a skilled craftsperson in the field in order to prepare the optical fiber for splicing, fusion or mechanical are typical splice methods, or for installation of a field installable fiber optic connector such as Corning's UniCam® No-Epoxy, No-Polish Connector or an anaerobic connector. Optical devices may comprise additional cases where the protective coatings of optical fibers need to be removed to expose base glass prior to assembly. In all cases, the removal of the protective coatings and buffering materials from the optical fiber is a very important process to assure the quality of the exposed glass during the field connectorization or splicing operations and for the environmental and mechanical performance of the resulting optical pathway.

There are a number of commercially available tools intended to strip buffered optical fiber down to the glass in a single step. For example, a wide variety of tools are available commercially for stripping the 250-micron acrylate coating. In the case of the 900-micron tight buffered fiber, the standard practice is to remove the 900-micron buffer first, leaving the 250-micron coated fiber to be stripped down to the 125-micron glass in a secondary operation. Several tools are commercially available to perform these two steps separately and perform successfully over extended lengths of optical fiber where the 900-micron buffer is lightly bonded to the 250-micron acrylate coating and can easily be separated.

However, while the few tools that are available may successfully strip some fibers, they are not capable of stripping the entire range of fibers produced by a wide variety of suppliers. In addition, some tools may strip short lengths, for example 10 mm, but are not capable of stripping longer lengths. For example, the above-described sequence fails in the case of optical fibers where the two protective coatings (900 and 250 microns) are strongly bonded together and are not easily separated. For such fibers, it is important to have a tool capable of stripping both coatings in a single step and for long segments. The tools that are commercially available for this task perform successfully for short segments of optical fiber at a time but do not function consistently over extended lengths. When using such tools, several passes can be used to consecutively remove a series of short strip lengths. However, repeating this process is tedious, adds time to the task, and can cause damage or degradation to the fiber due to the increased probability of inducing surface flaws with each distinct pass.

### SUMMARY

In one embodiment, a method of removing one or more coatings from an optical fiber is disclosed. The method includes inserting an optical fiber into an optical fiber stripper comprising a pair of fiber stress distributing elements and a cutting mechanism. The method also includes positioning the fiber stress distributing elements such that they contact a length of fiber intended to be stripped of one or more coatings. In addition, the method includes causing at least the length of fiber intended to be stripped to be moved in the direction of the cutting mechanism, wherein a normal stress is applied to the fiber by the fiber stress distributing elements along the length of fiber intended to be stripped.

In another embodiment, an optical fiber stripper for removing one or more coatings from an optical fiber is disclosed. The optical fiber stripper includes a pair of grip members each having a front end, a back end, and a longitudinal length, wherein the grip members are movable relative to each other from an open position to a closed position. The optical fiber stripper also includes a cutting mechanism. In addition, the optical fiber stripper includes a pair of fiber stress distributing elements. Each of the fiber stress distributing elements has a front end, a back end, and a longitudinal length. Each of the fiber stress distributing elements are positioned between the grip members and the cutting mechanism such that when the grip members are in the closed position, the fiber stress distributing elements are generally parallel with each other and with the grip members along their longitudinal lengths, and the grip members and the fiber stress distributing elements close onto the optical fiber material to be stripped. The longitudinal length of each of the fiber stress distributing elements is greater than the distance between the front end of the fiber stress distributing elements and the cutting mechanism.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character as it is claimed. The accompanying drawings are included to provide a further understanding, and are incorporated into and constitute a part of this specification. The drawings illustrate various embodiments, and together with the description serve to explain the principles and operation.

### BRIEF DESCRIPTION OF THE FIGURES

FIG. 1 is a perspective view of an embodiment of an optical fiber stripper as disclosed herein;

FIG. 2 depicts a first grip member of the optical fiber stripper of FIG. 1;

FIG. 3 depicts a second grip member of the optical fiber stripper of FIG. 1;

FIG. 4 depicts a cross-sectional view of the optical fiber stripper of FIG. 1 being used to strip one or more coatings of an optical fiber;

FIGS. 4A-4E respectively show details of a fiber slot and stripping edges of the optical fiber stripper of FIG. 1;

FIG. 5 is a top perspective view of another embodiment of a stripping device according to embodiments disclosed herein;

FIG. 6 is a side view of the device of FIG. 5;

FIG. 7A is a cross-sectional view of the device of FIG. 5 taken along lines 3A-3A in FIG. 6;

FIG. 7B is a cross-sectional view of the device as in FIG. 7A showing insertion of a transmission carrier (e.g., optical fiber) to be stripped;

FIG. 7C is a close-up cross-sectional view of an end of the stripping device as in FIG. 7A showing grip members in an open position;

FIG. 7D is a cross-sectional view of the stripping device as in FIG. 7A showing the grip members in a closed position, thereby at least partially cutting the outer material of the transmission carrier and clamping an end portion being removed;

FIG. 7E is a close-up cross-sectional view of the stripping device as in FIG. 7D;

FIG. 7F is a cross-sectional view of the stripping device showing removal of the stripped transmission carrier from the stripping device while the end portion of outer material is retained;

FIG. 8 is a side view of another embodiment of a stripping device according to embodiments disclosed herein; and

FIG. 9 depicts an exemplary cutting mechanism blade configuration that can be used with embodiments disclosed herein.

### DETAILED DESCRIPTION

Reference will now be made in detail to the preferred embodiments, examples of which are illustrated in the accompanying drawings. Whenever possible, like reference numbers will be used to refer to like components or parts. Embodiments described herein are explanatory methods and devices for preparing and/or terminating an end portion of a fiber optic cable. Moreover, the concepts disclosed advantageously allow for easily repeatable and reliable terminations by the craft. Reference will now be made in detail to the preferred embodiments, examples of which are illustrated in the accompanying drawings.

Embodiments described herein can enable the simultaneous stripping of optical fiber buffer and coating (such as 900 micron buffer coating over 125 micron glass) over an extended length of a variety of coating and buffer types in a single pass. Such embodiments include a method of removing one or more coatings from an optical fiber wherein an optical fiber is inserted into a device, such as an optical fiber stripper, that includes a pair of fiber stress distributing elements and a cutting mechanism. In operation, the fiber stress distributing elements are positioned such that they contact a length of fiber intended to be stripped of one or more coating and/or buffer layers, such as by clamping the fiber stress distributing elements around the fiber. At least the length of fiber intended to be stripped is then moved in the direction of the cutting mechanism, wherein the fiber stress distributing elements cause a normal stress to be applied to the fiber along the length of fiber intended to be stripped.

Embodiments described herein can enable the above-described normal stress to be optimized such that it does not increase the lateral compression on the coating and/or buffer tube, which can result in increased friction at the glass interface. Such normal stress application enables a mechanical friction or interlock on the coating and/or buffer tube that is in the opposite direction of the shear forces that are acting on the glass interface. This, in turn, balances the forces along the length of the fiber intended to be stripped and enables the distribution of localized compressive stresses that may develop as a result of coating and/or buffer tube material properties.

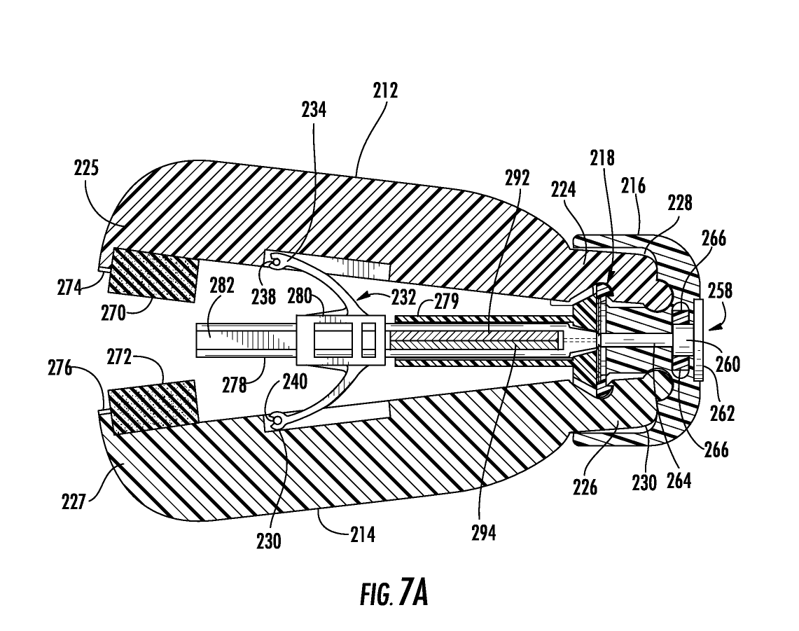

Embodiments described herein may also include one or more anchoring mechanisms (such as, for example, clamping members 270 and 272 shown in FIG. 5) on the opposite end of where the stripping force is applied, such as the opposite end of the device as the cutting mechanism. This can serve to further balance the forces along the length of the fiber intended to be stripped as well as reduce the resultant force that is applied to the glass during stripping.

Embodiments described herein may also include elimination of features included on previous designs that cause a continuous or abrupt change in the direction of shear forces that can develop during stripping and sliding of buffer and/or coating layers off of the glass. For example, embodiments described herein can include those in which the fiber alignment features to assure positioning of the buffered optical fiber to the cutting mechanism may be eliminated or significantly altered from previous designs.

Embodiments described herein can enable reliable simultaneous stripping of buffer and coating layers over extended lengths of a variety of coating types, wherein the longitudinal length of buffer and coating layer removed in a single pass is at least 10 millimeters, such as at least 15 millimeters, and further such as at least 20 millimeters, and yet further such as at least 40 millimeters. The types of coating and buffer materials that can be removed at such lengths in a single pass are not limited to any particular type of coating and can include, for example, coatings and buffer materials made from a variety of materials and containing various amounts of additives or colorants and, in turn, having a wide range of moduli of elasticity (Young's Modulus).

In general, the lower the Young's Modulus of the outer coating or buffer layer, the more difficult it is to remove an extended length of buffer and coating layer in a single pass because such lower modulus materials tend to deform locally thereby causing stress on the fiber to be concentrated as opposed to being more evenly distributed along the length of the fiber. Such uneven stress distribution can stress a glass fiber to its failure limit (e.g., 13-14 lbs) such that the fiber breaks as opposed to being stripped. This uneven stress distribution is the reason that fiber stripping tools currently available require multiple short length strips 10 millimeters to remove the coatings.

Accordingly, while some field-usable stripping tools may have been capable of reliably stripping lengths of coating or buffer materials of sufficiently high Young's modulus, they have been found to be incapable of reliably stripping extended lengths of lower modulus material in a single pass. In contrast, embodiments disclosed herein can enable stripping extended lengths (such as at least 20 millimeters) of both coating and buffer in a single pass wherein the outermost buffer layer has a Young's Modulus of less than 500 MPa, such as less than 400 MPa, and further such as less than 300 MPa, including between 200 MPa and 1000 MPa.

Exemplary embodiments that can be used to perform the above-described method will now be described in more detail.

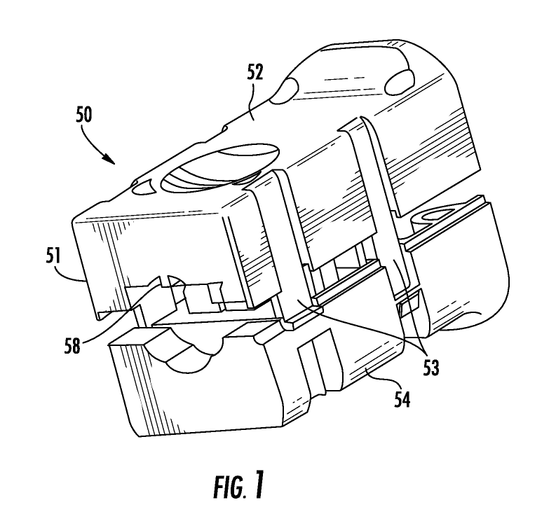

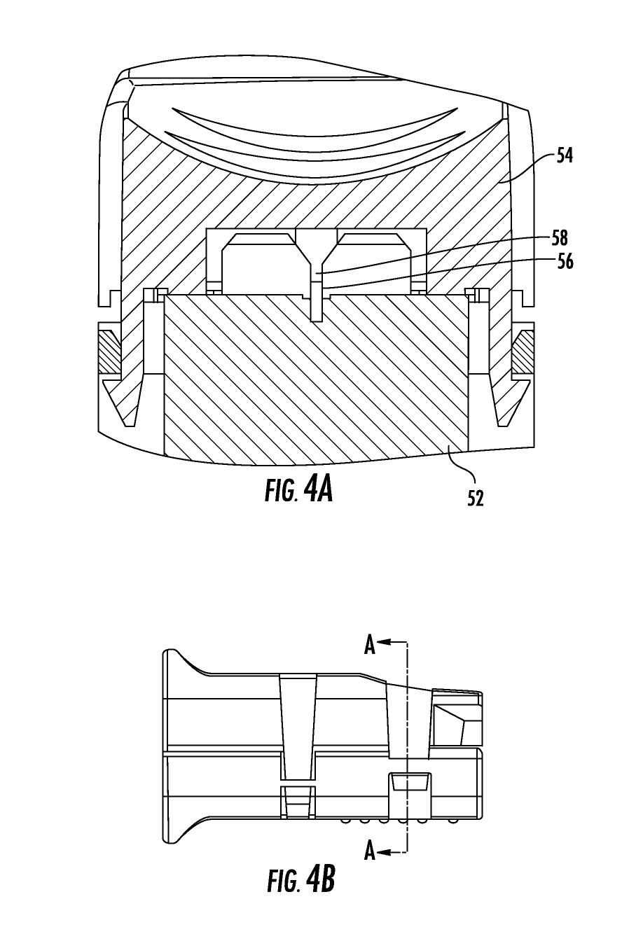

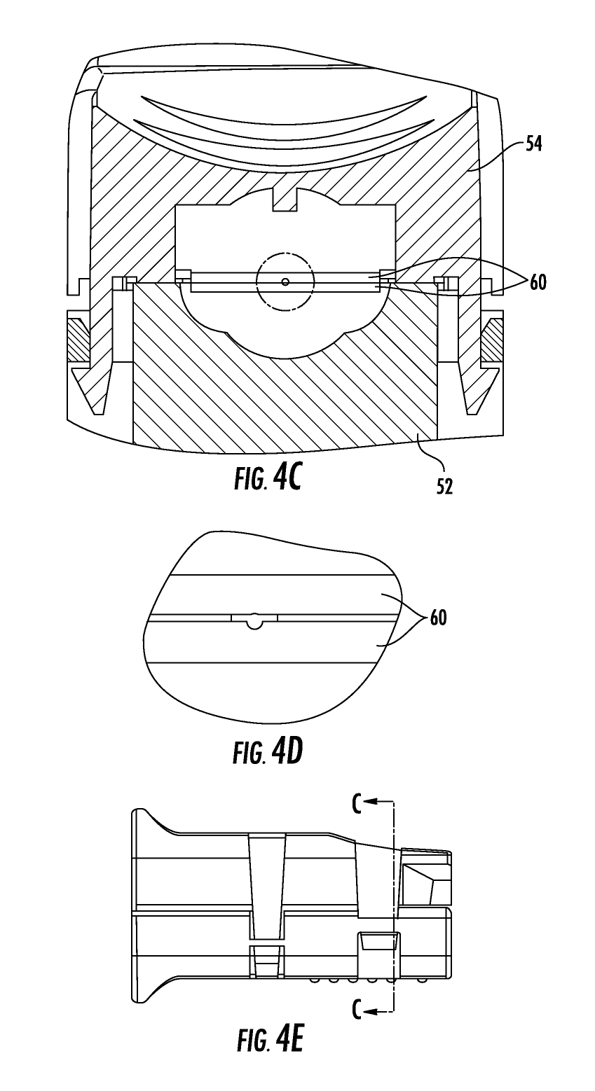

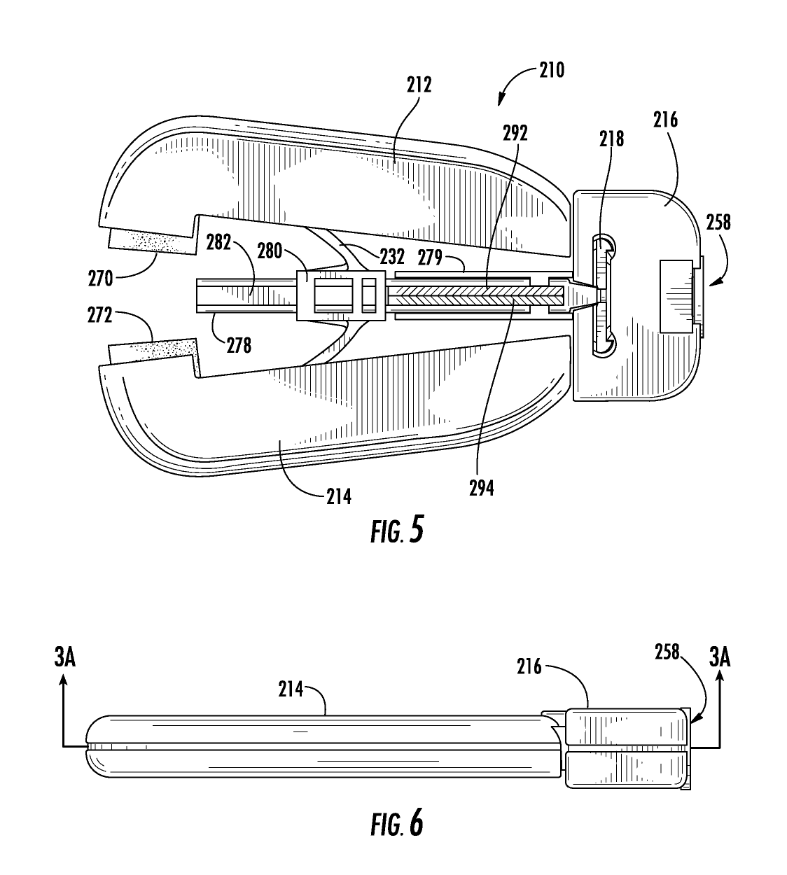

FIG. 1 is a perspective view of an optical fiber stripper 50 (hereinafter stripper) used for removing one or more coatings from optical fiber 30. For instance, stripper may be used for removing the buffer layer 34 (as shown in FIG. 4) and/or a coating (not visible) on optical fiber 30. Stripper 50 includes a first grip member 52 and a second grip member 54. First grip member 52 attaches to the second grip member 54 and can translate relative to the first grip member 52 from an open position (FIG. 1) to a closed position to grip the optical fiber therein. For instance, stripper 50 includes a plurality of latches 53 for attaching the second grip member 54 to the first grip member 52. As can be seen in FIG. 1, grip members 52, 54 are generally parallel to each other along their longitudinal lengths when the grip members 52, 54 are in the open position.

After optical fiber 30 is inserted into the stripper 50 by a suitable distance such as extending to the far end of the stripper 50, the stripper 50 can be closed by moving the second grip member 54 and first grip member 52 together. The overall length of stripper 50 can be selected to function as a stripping gauge or fiber measurement guide. In other words, when the craft views the optical fiber lining up with or extending from a far end of the stripper 50 they know a suitable length of the optical fiber is being stripped for the termination and connectorization process (i.e., cleaving and connectorization). Additionally, moving the second grip member 54 and first grip member 52 together brings the optical fiber 30 into the proper location within the stripper 50 for stripping the one or more coatings therefrom as discussed below. Thereafter, the optical fiber 34 can be pulled away from stripper 50 to remove the one or more coatings from the optical fiber

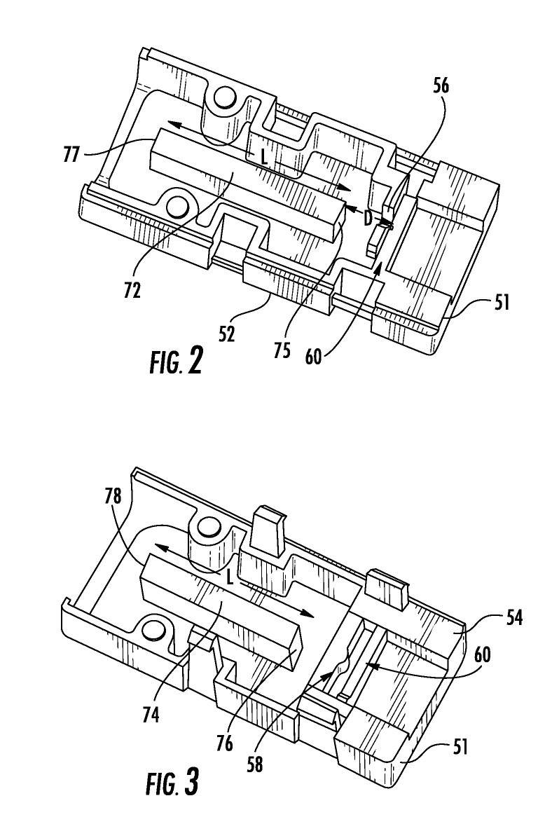

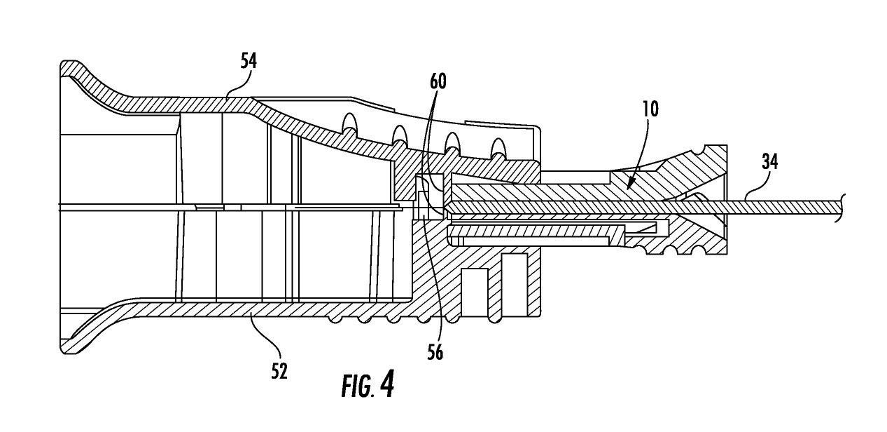

FIGS. 2 and 3 respectively depict the first grip member 52 and second grip member 54 of stripper 50 showing the respective internal details of the portions. One of the second grip member 54 or the first grip member 52 includes a fiber slot 56 and the other portion includes a pushing surface 58 for advancing the optical fiber into the fiber slot 56. A first stripping edge of cutting mechanism 60 is disposed adjacent to the fiber slot 56 toward the receiving end 51. Likewise, a second stripping edge of cutting mechanism 60 is disposed adjacent to the pushing surface 58 toward the receiving end 51. In this embodiment, the second grip member 54 and first grip member 52 translate in a linear direction (i.e., in the direction of the fiber slot 56) when pushed together, but other embodiments can translate the portions in another direction such as rotational or the like. For instance, the second grip member and first grip member may translate in a rotational manner about a living hinge connecting respective sides of the portions.

As shown in FIGS. 2 and 3, first grip member 52 houses a first fiber stress distributing element 72 and second grip member 54 houses a second fiber stress distributing element 74. Each of first fiber stress distributing element 72 and second fiber stress distributing element 74 has a front end 75, 76, a back end 77, 78, and a longitudinal length L. First fiber stress distributing element 72 is engaged by first grip member 52 and second fiber stress distributing element 74 is engaged by second grip member 54. As can be seen in FIGS. 5 and 6, the longitudinal length L of each of the fiber stress distributing elements 72, 74 is greater than the distance D between the front ends 75, 76 of the fiber stress distributing elements 72, 74 and the cutting mechanism 60.

In certain exemplary embodiments, the longitudinal length L of each of the fiber stress distributing elements 72, 74 is at least 90% as long as the longitudinal length of fiber intended to be stripped, such as at least 10 millimeters, and further such as at least 15 millimeters, and still further such as at least 18 millimeters, and still yet further such as at least 36 millimeters. However, the longitudinal length L of the fiber stress distributing elements 72, 74 may vary to as short as 50% or as long as 200% of the length of the fiber to be stripped. In certain exemplary embodiments, the longitudinal length L of each of the fiber stress distributing elements 72, 74 is at least 2 times, such as at least 5 times, and further such as at least 10 times the distance D between the front ends 75, 76 of the fiber stress distributing elements and the cutting mechanism 60. In certain exemplary embodiments, the distance D between the front ends 75, 76 of the fiber stress distributing elements 72, 74 and the cutting mechanism 60 is less than 5 mm, such as less than 2 mm, and further such as less than 1 mm, including substantially adjacent to the cutting mechanism 60.

FIGS. 4A-4E depicts views of stripper 50 to strip one or more coatings from the optical fiber 30. When second grip member 54 and first grip member 52 are closed onto the optical fiber, the pushing surface 58 pushes the optical fiber into the fiber slot 56. In addition, when the grip members 52, 54 are in the closed position, the fiber stress distributing elements 72, 74 are generally parallel with each other and with the grip members 52, 54 along their longitudinal lengths.

FIG. 4A shows a detailed cross-sectional view of fiber slot 56 and pushing surface 58 in the closed position. Pushing the optical fiber into fiber slot 56 aligns the optical fiber 34 to the cutting mechanism 60. As shown in this embodiment, pushing surface 58 may include a convex portion (not numbered) facing receiving end 51 that cooperates (i.e., has a complementary shape) with a concave portion of the fiber slot 56. This arrangement of the convex and concave portions allows a close fit between the pushing surface 58 and the fiber slot 56, thereby guiding and forcing the optical fiber into the fiber slot 56. Fiber slot 56 can have any suitable shape or geometry for positioning the optical fiber 34 into the cutting mechanism 60 and breaking the upcoating (i.e., buffer layer) on the optical fiber. Simultaneously, the fiber stress distributing elements 72, 74 distribute stress away from the portion of the fiber closest to cutting mechanism 60 by distributing the stress along the length of the fiber contacted by the fiber stress distributing elements 72, 74 along their lengths L. In the closed position, fiber stress distributing elements 72, 74 may contact each other.

By way of example, fiber slot 56 has a lead-in portion (i.e., a v-shaped entry) for aligning and centering the optical fiber as it engages the same, thereafter the walls of the slot have a generally parallel orientation to open and separate the upcoating on the optical fiber. Moreover, when stripper 50 is in the closed position the fiber slot 56 fits between the pushing surface 58 and stripping edge of cutting mechanism 60 on the other portion. Consequently, the portion of the upcoating on the optical fiber being removed is held within fiber slot 56 as the craftsman pulls the optical fiber 34 away from the receiving end 51 of stripper 50. In this embodiment, the fiber slot 56 is an integral portion of the second grip member 54, but other embodiments can have the fiber slot removably attached to a portion of the stripper for replacement or reconfiguring the stripping sizing. Likewise, this embodiment depicts the first and second stripping edges of cutting mechanism 60 integrally formed with the respective grip members 52, 54; however, other embodiments may have the first and second stripping edges of cutting mechanism 60 that are inserts removably attached respectively to the grip members 52, 54 so they can be replaced and/or reconfigured for different types of optical fibers. Examples include different buffer material characteristics, material properties, or different fiber outside diameters.

Stripping edges of cutting mechanism 60 are used for removing the coating of the optical fiber over the desired portion, thereby exposing the bare optical fiber (i.e., the cladding of the optical fiber that surrounds the core). For instance, a typical optical fiber has a 250 micron coating that when removed leaves a 125 micron optical fiber that contains the core and cladding. FIG. 4C shows a detailed cross-sectional view of stripping edges of cutting mechanism 60 in the closed position. In one embodiment, the stripping edges of cutting mechanism 60 have a planar edge surface and are made from a material that deforms when engaging the optical fiber. In other words, the stripping edges of cutting mechanism 60 experiences a deformation about the optical fiber disposed therebetween so it acts as a wiping surface to remove one or more coatings from the optical fiber. Stated another way, the stripping edges of cutting mechanism 60 experiences a deformation of approximately one fiber diameter therebetween when closed onto the optical fiber so that the edges wipe away the optical fiber coating as the optical fiber 34 is pulled away from stripper 50. For instance, the material used for the stripping edge may have a bending elasticity in the range of about 900 to 20,000 MPa. One suitable material having a bending elasticity in this range is a polycarbonate, but other suitable materials are possible. Additionally, stripping edges of cutting mechanism 60 may be straight or angled downward towards the receiving end 51 of stripper 50 as shown. In other embodiments, the stripping edges may be made from a material that does not deform when closed onto the optical fiber, but instead have a profile that accommodates the optical fiber and acts to wipe the coating from the optical fiber.

FIGS. 5-7E show another example of a stripping device 210 according to embodiments disclosed herein. As shown, stripping device 210 includes grip members 212 and 214 pivotally mounted to an end block 216. A scoring or cutting mechanism 218 (hereinafter cutting mechanism) is disposed within end block 216 and is actuated by a pivoting of grip members 212 and 214. As discussed below, various mechanisms may be employed to hold a coated and/or jacketed transmission carrier (e.g., optical fiber) 220 to allow stripping of an end portion 222 of outer material from the transmission carrier by inhibiting buckling of the transmission carrier during use of the device.

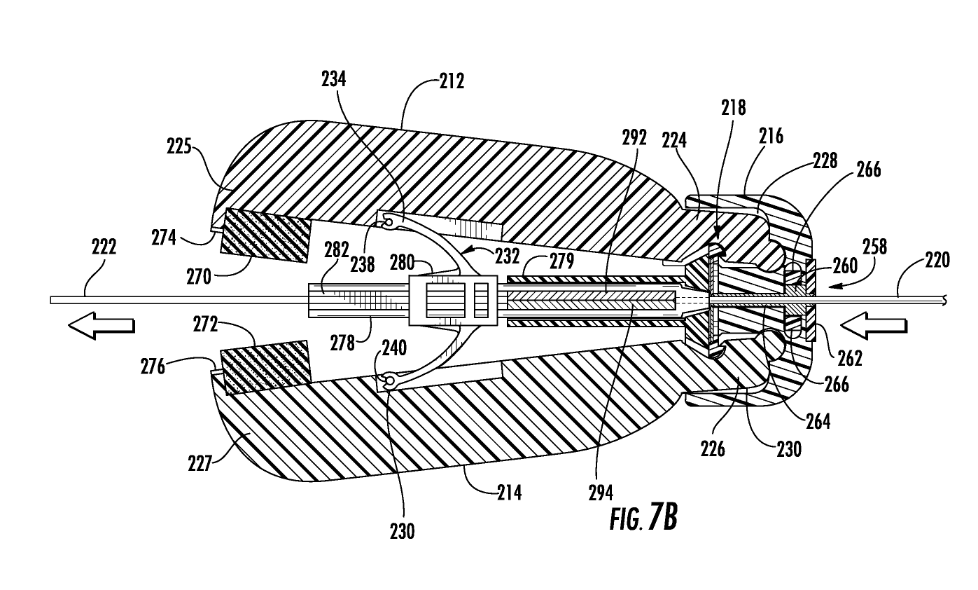

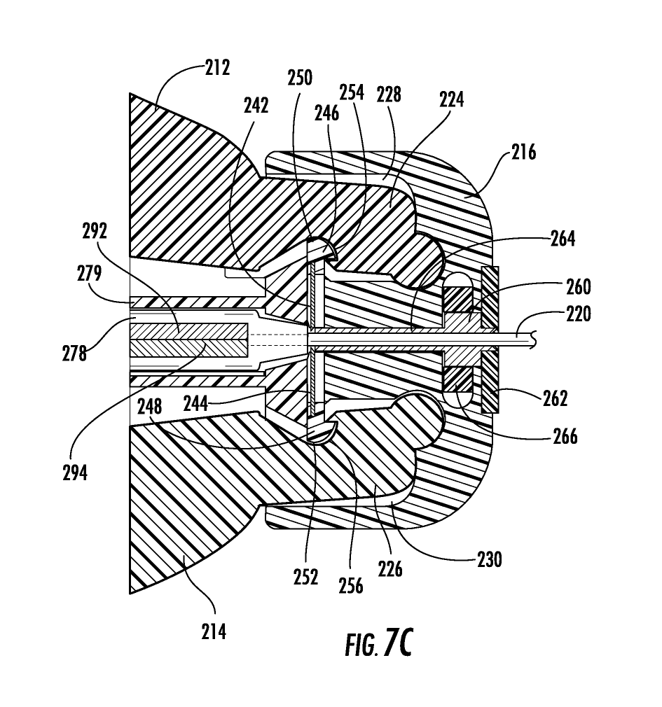

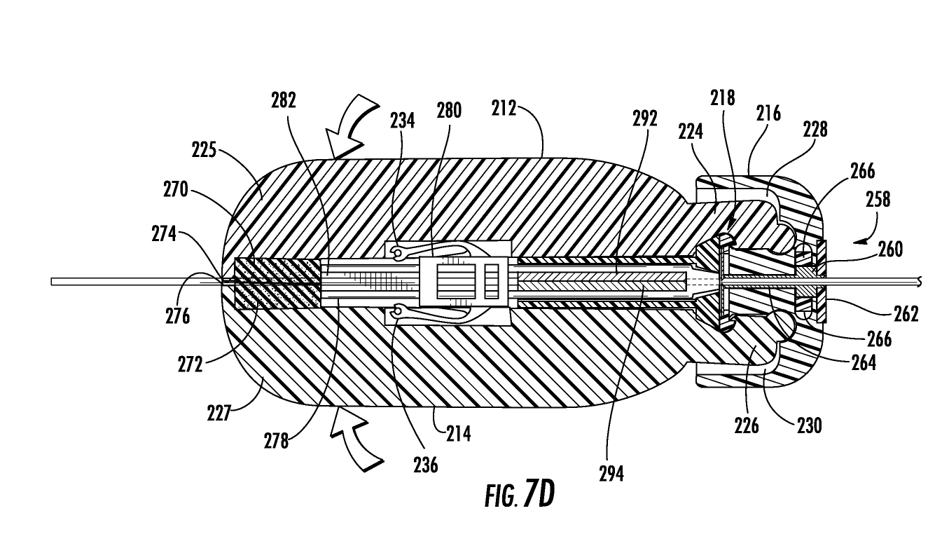

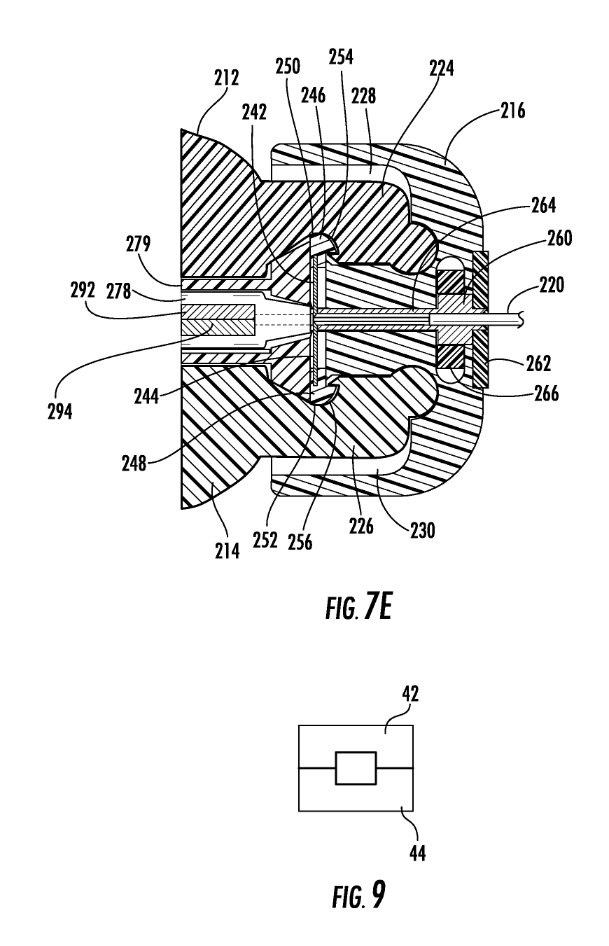

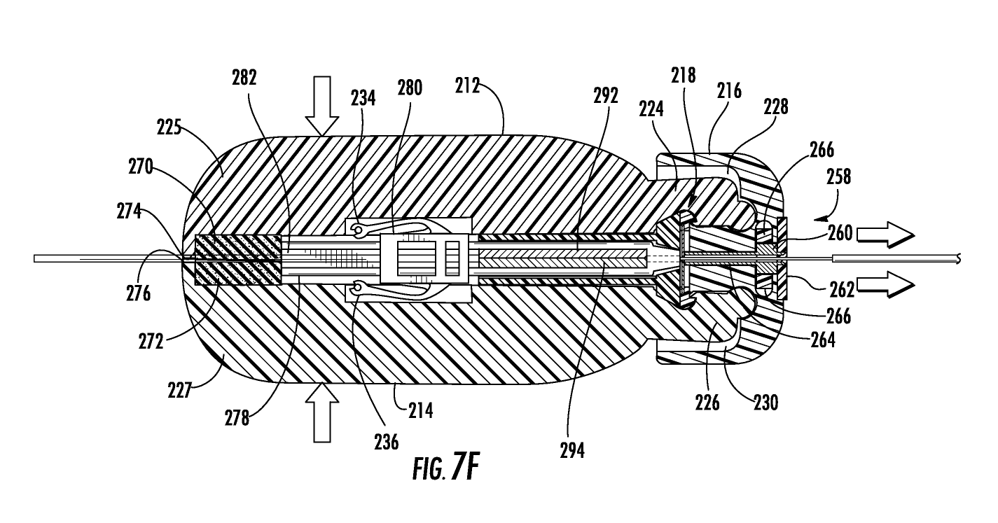

As shown in FIG. 7A, grip members 212 and 214 each include heel ends 224 and 226 pivotally disposed within cavities 228 and 230 formed in end block 216. A spring member 232 may be attached to at least one of grip members 212 and 214 to urge grip members toward the open position, as shown in FIG. 7A. Spring member 232 as shown comprises a dual leaf-spring member having two ends 234 and 236 attached to pins 238 and 240 formed on grip members 212 and 214.

As best shown in FIGS. 7C and 7E, cutting mechanism 218 includes two movable cutting blade elements 242 and 244 carried by carriers 246 and 248 disposed within end block 216. Ends 250 and 252 of carriers 246 and 248 are located within recesses 254 and 256 formed within grip members 212 and 214. Movement of grip members 214 and 216 from the open position shown in FIG. 7A to the closed position shown in FIG. 7D causes blade elements 242 and 244 to come together (see close-up views in FIGS. 7C and 7E) to cut into the outer material 220, thereby creating the end portion 222 for removal. In this embodiment, blade elements 242 and 244 are sized with an aperture therebetween (discussed below) for merely scoring the outer material, thereby inhibiting damage to the same. Additionally, spring member 232 biases blade elements 242 and 244 toward the open position, shown in FIG. 7C, and compressing grip members 212 and 214 together moves the blades to the cutting position shown in FIG. 7E.

A transmission carrier (e.g., optical fiber) insert guide 258 may be attached to end block 216 to guide the transmission carrier through the end block and past cutting mechanism 218. Transmission carrier insert guide 258 may be a removable and replaceable part sized for a particular diameter, shape, and/or size of the transmission carrier. Accordingly, a family of such transmission carrier insert guides may be provided for a given stripping device so that various sizes of transmission carriers may be accurately stripped using stripping device 210. Likewise, blade elements 242 and 244 can be removed and accordingly sized for particular transmission carrier geometry. Transmission carrier insert guide 258 may include a body portion 260, an outer flange 262, and a neck section 264 sized to receive the particular transmission carrier to be stripped. A removable guide lock 266 may be used to hold the selected transmission carrier insert guide 258 in place within end block 216.

In addition to the fiber stress distributing elements 292 and 294 discussed below, various forms of an alignment mechanism may be employed to ensure transmission carrier 220 is held and may be stripped without buckling. For example, as shown in FIG. 5, at least one clamping member 270 may be attached to a grip member 212. If desired, a second clamping member 272 may be attached to the other grip member 214. Clamping members 270 and 272 may be formed of a foam material or other suitable compliant material. As shown in FIG. 7D, when grip members 212 and 214 are brought together so as to move cutting mechanism 218 into the cutting position, clamping members 270 and 272 are compressed together to thereby hold transmission carrier 220 therebetween. Clamping members 270 and 272 apply sufficient clamping force for the stripping of the coating or jacket.

Clamping members 270 and 272 should be sized and/or selected of a material such that the clamping members may hold the coated transmission carrier 220 with a clamping force suitable to hold the transmission carrier and allow the fiber or wire to be stripped without damaging the fiber or wire. However, the coated transmission carrier 220 should not be gripped so tightly that the inner transmission carrier portion 220 is damaged. Rather, the clamping force should suitably hold the transmission carrier and to allow stripping of the end portion of outer material while inhibiting buckling during the stripping of the outer material.

Alternatively, or in addition to clamping members 270 and 272, an alignment mechanism may include a relief passage 274 disposed in at least one grip member toe portion 225. As shown, mating relief passages 274 and 276 may be provided opposite each other in toe portions 225 and 227. Relief passages 274 and 276 should be sized and/or shaped large enough so as to allow for clamping and stripping, as described above. Preferably, the relief passages are made larger than the outer material 220b of the transmission carrier, thereby allowing clamping members 270 and 272 to perform the clamping. Alternately, appropriate relief passages 274 and 276 could be used alone, without clamping members 270 and 272. In such case, the relief passages would have a predetermined size suitable for the outer diameter and/or shape of transmission carrier being stripped. In other embodiments, relief passages 274 and 276 could also be omitted entirely, if desired performance was achieved.

As shown in FIG. 7A, a guide 278 is provided extending from mounting structure 279 attached to end block 216. Guide 278 extends toward toe portions 225 and 227. Guide 278 houses two fiber stress distributing elements 292 and 294.

In certain exemplary embodiments, the longitudinal length L of each of the fiber stress distributing elements 292, 294 is at least 90% as long as the longitudinal length of fiber intended to be stripped, such as at least 10 millimeters, and further such as at least 15 millimeters, and still further such as at least 18 millimeters, and still yet further such as at least 36 millimeters. In certain exemplary embodiments, the longitudinal length of each of the fiber stress distributing elements 292, 294 is at least 2 times, such as at least 5 times, and further such as at least 10 times the distance between the front ends of the fiber stress distributing elements and the cutting mechanism 218. In certain exemplary embodiments, the distance between the front ends of the fiber stress distributing elements 292, 294 and the cutting mechanism 218 is less than 5 mm, such as less than 2 mm, and further such as less than 1 mm, including substantially adjacent to the cutting mechanism 218.

The guide may include structure for heating the transmission carrier outer material for improved cutting, if desired (not shown). Guide 278 may also extend at least some distance beyond the fiber stress distributing elements 292 and 294 to provide a channel 282 for loosely guiding transmission carrier 220 toward alignment mechanism(s) located at toe ends 225 and 227 of grip members 212 and 214. Spring member 232 may include a follower portion 280 disposed about guide 278 so as to maintain alignment of the spring member.

FIGS. 7A-7F show a sequence of stripping a transmission carrier using stripping device 210. In FIG. 7A, stripping device 210 is in the open position ready for receipt of a coated transmission carrier 220. Cutting mechanism 218 and transmission carrier insert guide 258 portions will have been selected so as to fit the particular coated transmission carrier 220 to be stripped.

FIG. 7B shows the feeding of the coated transmission carrier 220 into stripping device 210 via transmission carrier insert guide 258 disposed in end block 216. Transmission carrier 220 may be extended all the way through stripping device 210 past toe ends 225 and 227 of grip member 212, if desired. FIG. 7C shows a close-up of the position of cutting mechanism 218 in end block 216 at this point. It should also be understood that stripping device 210 may be utilized to cut substantially shorter portions of transmissions carriers, (i.e. transmission carrier portions not extending to toe ends 225 and 227).

FIG. 7D depicts stripping device 210 after the pivoting of grip members 212 and 214 together in a closed position so as to clamp coated transmission carrier 220 between fiber stress distributing elements 292 and 294, clamping members 270 and 272, and held within relief passages 274 and 276. As shown in FIG. 7E, at this point blade elements 242 and 244 of cutting mechanism 218 at least partially cut through the outer portion of transmission carrier 220 creating an end portion 222 to be stripped off. When the grip members 212 and 214 are in the closed position, the fiber stress distributing elements 292 and 294 may contact each other.

FIG. 7F shows the pulling of coated transmission carrier 220 away from end block 216, thereby stripping end portion 222 from a portion of carrier 220. Buckling is inhibited along the stripped portion because fiber stress distributing elements 292 and 294 and clamping members 270 and 272 grip transmission carrier 220 allowing for relatively long strip lengths, more accurate stripping, and inhibiting damage to the signal carrying optical fiber or wire within the transmission carrier. Further pulling of coated transmission carrier 220 from stripping tool 210 removes end portion 222 leaving the stripped transmission carrier 220 exposed for further termination procedures.

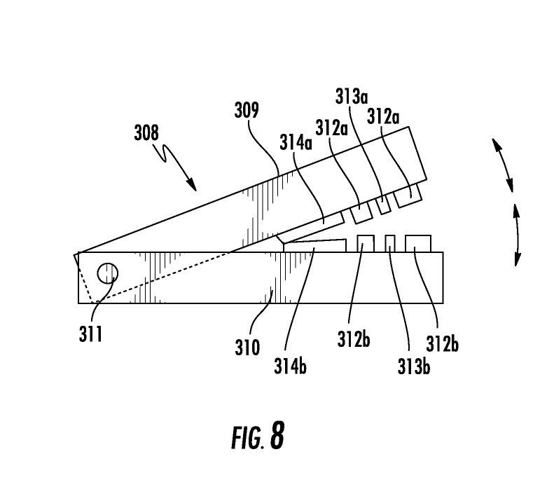

FIG. 8 shows a side view of another embodiment of a stripping device according to embodiments disclosed herein. In FIG. 8, a stripping device 308 is provided with a pair of grip members 309 and 310 that are pivotally attached to each other with a pivot 311 at their back ends and rotatable around the pivot 311 in the directions as shown by arrows. The grip members 309 and 310 are provided with two pairs of clamps 312a and 312b located at front end portions thereof for grasping a terminal portion of a jacketed optical fiber (not shown). The clamps 312a and 312b are provided with grooves with a V-shaped cross sectional profile (not shown) for receiving the terminal portion of the jacketed optical fiber (not shown). Between the clamps 312a and 312b, a cutting mechanism comprising a pair of cutting blades 313a and 313b are arranged. Positioned along the lengths of the grip members 309 and 310 are a pair of fiber stress distributing elements 314a and 314b. As can be seen in FIG. 8, the longitudinal length of each of the fiber stress distributing elements 314a and 314b is greater than the distance between the front end of the fiber stress distributing elements 314a and 314b and the cutting mechanism.

When the grip members 309 and 310 of the stripping device 308 are pushed opposite to each other, the fiber stress distributing elements 314a and 314b are generally parallel with each other and with the grip members 309 and 310 along their longitudinal lengths, such that a portion of the jacketed optical fiber proximate the terminal portion of the fiber is clamped by the fiber stress distributing elements 314a and 314b. In addition, the terminal portion of the jacketed optical fiber is grasped by the two pairs of clamps and the jacket layer of the grasped jacketed optical fiber is cut by the cutting mechanism.

In certain exemplary embodiments, the longitudinal length L of each of the fiber stress distributing elements 314a, 314b is at least 90% as long as the longitudinal length of fiber intended to be stripped, such as at least 10 millimeters, and further such as at least 15 millimeters, and still further such as at least 18 millimeters, and still yet further such as at least 36 millimeters. In certain exemplary embodiments, the longitudinal length of each of the fiber stress distributing elements 314a, 314b is at least 2 times, such as at least 5 times, and further such as at least 10 times the distance between the front ends of the fiber stress distributing elements and the cutting mechanism. In certain exemplary embodiments, the distance between the front ends of the fiber stress distributing elements 314a, 314b and the cutting mechanism is less than 5 mm, such as less than 2 mm, and further such as less than 1 mm, including substantially adjacent to the cutting mechanism. The fiber stress distributing elements 314a, 314b may contact each other when the grip members 309, 310 are in the closed position.

In embodiments disclosed herein, at least one of the fiber stress distributing elements comprises a textured metal plate, a hard plastic material, an abrasive coated or impregnated material, sandpaper or any other material that applies a normal force to the fiber and increases the coefficient of friction between the fiber coating and the fiber stress distributing element. In exemplary embodiments, at least one of the fiber stress distributing elements provides a mechanical interlock that effectively balances the applied axial force on the fiber (i.e., the force that pulls the fiber through the cutting mechanism) so as to strip the coatings off the fiber with minimal compression.

In certain exemplary embodiments disclosed herein, at least one of the fiber stress distributing elements comprises a material that deforms elastically but does not substantially deform plastically when applied with a force of up to about 2 pounds against a buffered optical fiber. For example, at least one of the fiber stress distributing elements can comprise a resilient material selected from the group consisting of synthetically produced thermoplastic vulcanizates and natural rubber. Examples of synthetically produced thermoplastic vulcanizates include Santroprene™ available from ExxonMobil and engineering thermoplastic vulcanizates (ETPV) available from DuPont. Additional exemplary materials include Kraton or Dynaflex available from GLS, Evoprene™ available from Alpha Gary, and Arnitel available from DSM.

In embodiments disclosed herein, the cutting mechanism can be configured so as to comprise an aperture or opening when the grip members are in the closed position. An example of such a cutting mechanism is illustrated in FIG. 9. Movement of grip members, for example, from the position shown in FIG. 7A to the position shown in FIG. 7D, causes blades 42 and 44 to come together, resulting in aperture or opening between them. In certain exemplary embodiments, the opening has an aspect ratio (longest dimension divided by shortest dimension) of at least 2, such as at least 5, and further such as at least 10, including from 2 to 20, and further including from 5 to 15. In certain exemplary embodiments, the opening has an oval or elliptical cross-section. In certain exemplary embodiments, the opening has a rectangular cross-section. When having a rectangular cross-section, the corners of the rectangle may be square or rounded.

Although preferred embodiments and specific examples were illustrated and described herein, it will be readily apparent to those of ordinary skill in the art that other embodiments and examples can perform similar functions and/or achieve like results. All such equivalent embodiments and examples are within the spirit and scope of the present disclosure and are intended to be covered by the appended claims. It will also be apparent to those skilled in the art that various modifications and variations can be made to the embodiments shown. Thus, it is intended that the disclosure and/or claims cover the modifications and variations.

We claim:

1. An optical fiber stripper for removing one or more coatings from an optical fiber, comprising;
a pair of grip members each having a front end, a back end, and a longitudinal length, wherein the grip members are movable relative to each other from an open position to a closed position;
a cutting mechanism; and
a pair of fiber stress distributing elements, each having a front end, a back end, and a longitudinal length, each of which are positioned such that when the grip members are in the closed position, the fiber stress distributing elements are generally parallel with each other and with the grip members along their longitudinal lengths and wherein the longitudinal length of each of the fiber stress distributing elements is greater than the distance between the front end of the fiber stress distributing elements and the cutting mechanism.

2. The optical fiber stripper of claim 1, wherein the fiber stress distributing elements contact each other when the grip members are in the closed position.

3. The optical fiber stripper of claim 1, wherein the longitudinal length of each of the fiber stress distributing elements is at least 2 times the distance between the front end of the fiber stress distributing elements and the cutting mechanism.

4. The optical fiber stripper of claim 1, wherein the longitudinal length of each of the fiber stress distributing elements is at least 90% of the longitudinal length of the fiber intended to be stripped.

5. The optical fiber stripper of claim 1, wherein at least one of the fiber stress distributing elements comprises a material that deforms elastically but does not substantially deform plastically when applied with a force of up to about 2 pounds against a buffered optical fiber.

6. The optical fiber stripper of claim 1, wherein the cutting mechanism is configured so as to comprise an opening when the grip members are in the closed position, said opening having an aspect ratio of at least 2.

7. The optical fiber stripper of claim 1, wherein the cutting mechanism comprises two cutting blade elements that are movable relative to each other.

8. The optical fiber stripper of claim 1, wherein the grip members are generally parallel to each other along their longitudinal lengths when the grip members are in the open position, the optical fiber stripper further comprising latches for attaching the grip members to each other.

9. The optical fiber stripper of claim 1, further comprising an end block, wherein each of the grip members are pivotally attached to the end block at their front ends.

10. The optical fiber stripper of claim 9, wherein the cutting mechanism comprises two cutting blade elements that move relatively closer to each other when the grip members are moved relative to each other from an open position to a closed position.

11. The optical fiber stripper of claim 1, wherein each of the grip members are pivotally attached to each other at their back ends.

12. The optical fiber stripper of claim 11, wherein the cutting mechanism comprises two cutting blade elements that move relatively closer to each other when the grip members are moved relative to each other from an open position to a closed position.

13. The optical fiber stripper of claim 1, wherein the stripper further comprises at least one anchoring mechanism on the opposite end of the device as the cutting mechanism.

14. A method of removing one or more coatings from an optical fiber, the method comprising:
inserting an optical fiber into an optical fiber stripper comprising a pair of fiber stress distributing elements and a cutting mechanism;
positioning the fiber stress distributing elements such that they contact a length of fiber intended to be stripped of one or more coatings;
causing at least the length of fiber intended to be stripped to move in the direction of the cutting mechanism, wherein a normal stress is applied to the fiber by the fiber stress distributing elements along the length of fiber intended to be stripped.

15. The method of claim 14, wherein the fiber stress distributing elements each have a front end, a back end and a longitudinal length, wherein the longitudinal length of each of the fiber stress distributing elements is greater than the distance between the front end of the fiber stress distributing elements and the cutting mechanism.

16. The method of claim 14, wherein the method is capable of removing at least 20 millimeters of coating and buffer from an optical fiber in a single pass.

17. The method of claim 16, wherein the buffer has a Young's Modulus of less than 500 MPa.

18. The method of claim 14, wherein the longitudinal length of each of the fiber stress distributing elements is at least 50% of the longitudinal length of the fiber intended to be stripped.

19. The method of claim 14, wherein the cutting mechanism comprises two cutting blade elements that move relatively closer to each other when the grip members are moved relative to each other from an open position to a closed position.

20. The method of claim 14, wherein the cutting mechanism is configured so as to comprise an opening when the grip members are in the closed position, said opening having an aspect ratio of at least 2.
